(19) United States
(12) Patent Application Publication
(10) Pub. No.: US 2025/0303932 A1
(43) Pub. Date: Oct. 2, 2025

(54) EXTENDABLE SEATBACK

(71) Applicant: Ford Global Technologies, LLC, Dearborn, MI (US)

(72) Inventors: Mohammad Omar Faruque, Ann Arbor, MI (US); S.M. Iskander Farooq, Novi, MI (US); Dean M. Jaradi, Macomb, MI (US)

(73) Assignee: Ford Global Technologies, LLC, Dearborn, MI (US)

(21) Appl. No.: 18/624,229

(22) Filed: Apr. 2, 2024

(51) Int. Cl. B60N 2/22; B60N 2/00; B60N 2/803; B60R 21/015; B60R 22/34

(52) U.S. Cl. CPC B60N 2/22; B60N 2/002; B60N 2/803; B60R 21/01512; B60R 22/34; B60N 2002/2204

(57) ABSTRACT

A system including a seatback frame having a lower frame and an upper frame carried by and movable relative to the lower frame between a retracted position and an extended position. An actuator is operatively coupled to the upper frame to move the upper frame between the retracted position and the extended position.

### BACKGROUND

A vehicle may include a seat and a seatbelt assembly. The seat can include a seatback and a seat bottom that can support an occupant of the seat. For example, the occupant of the seat may sit on a top surface of the seat bottom and recline against the seatback. The seatbelt assembly may include a seatbelt retractor and webbing retractably payable from the seatbelt retractor. The seatbelt assembly may include an anchor coupled to the webbing, and a latch plate that engages a buckle. The seatbelt assembly may be disposed adjacent to a seat of the vehicle. The webbing may extend continuously from the seatbelt retractor through a webbing guide to the anchor. For example, one end of the webbing feeds into the seatbelt retractor, and the other end of the webbing is fixed to the anchor.

### BRIEF DESCRIPTION OF THE DRAWINGS

FIG. 1A is a side view of a seat assembly including an extendable seatback in a retracted configuration.

FIG. 1B is a side view of the seat assembly shown in FIG. 1A with the seatback in an extended configuration.

FIG. 2 is an enlarged partial perspective view of the seatback shown in FIG. 1B as viewed from the rear of the seat assembly.

FIG. 3 is a block diagram of a system of the vehicle.

FIG. 4 is a is a flowchart of a method executable by a vehicle computer.

### DETAILED DESCRIPTION

A system including a seatback frame having a lower frame and an upper frame carried by and movable relative to the lower frame between a retracted position and an extended position. An actuator is operatively coupled to the upper frame to move the upper frame between the retracted position and the extended position.

The seat system can include a webbing guide fixed to and movable with the upper frame.

The seat system can include a retractor supported by the seatback frame.

The retractor can be supported by the lower frame.

The seat system can include a webbing extending from the retractor through the webbing guide.

The seat system can include a seat bottom, a latch plate slidably disposed on the webbing, and a buckle attached to the seat bottom and operative to releasably engage the latch plate.

The seat system can include ahead restraint supported by and movable with the upper frame.

The actuator can be a rack and pinion mechanism coupled to the upper frame and operative to move the upper frame between the retracted position and the extended position.

The rack and pinion mechanism can include a pinion gear and a gear rack, the gear rack being secured to the upper frame.

The seat system can include a seatback cover including a lower portion and an upper portion at least partially overlapping the lower portion.

The upper frame can include a leg member slidingly engaged with the lower frame.

The upper frame and the lower frame can telescope relative to each other.

The seat system can include a computer having a processor and a memory storing instructions executable by the processor to activate the actuator and to move the upper frame between the retracted position and the extended position in response to determining that an occupant is seated in the seat.

The instructions can include instructions to adjust the position of the upper frame relative to the lower frame based on a determined size of the occupant.

The seat system can include an occupancy sensor.

The seat system can include a webbing guide fixed to and movable with the upper frame.

The seat system can include a head restraint supported by and movable with the upper frame.

The seat system can include a seat bottom, a latch plate slidably disposed on a webbing, and a buckle attached to the seat bottom and operative to releasably engage the latch plate.

The actuator can be a rack and pinion mechanism coupled to the upper frame and operative to move the upper frame between the retracted position and the extended position.

The upper frame and the lower frame can telescope relative to each other.

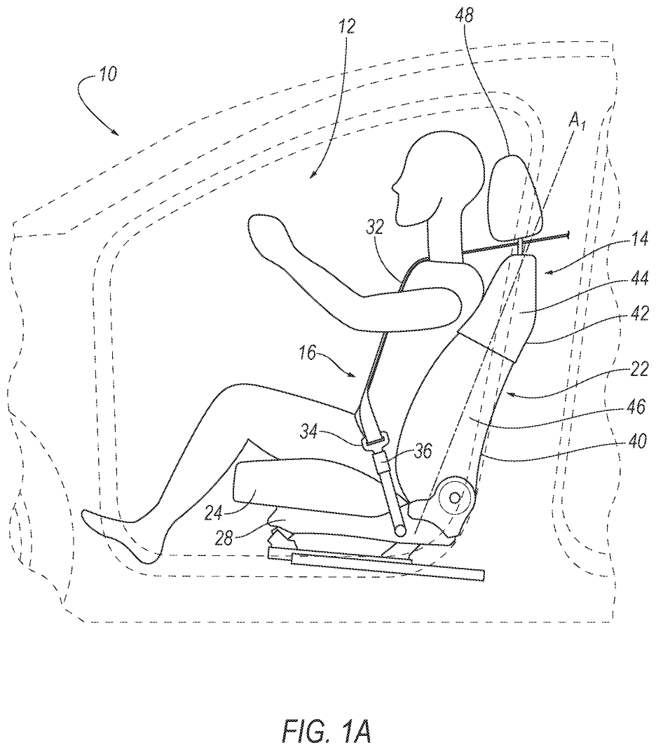

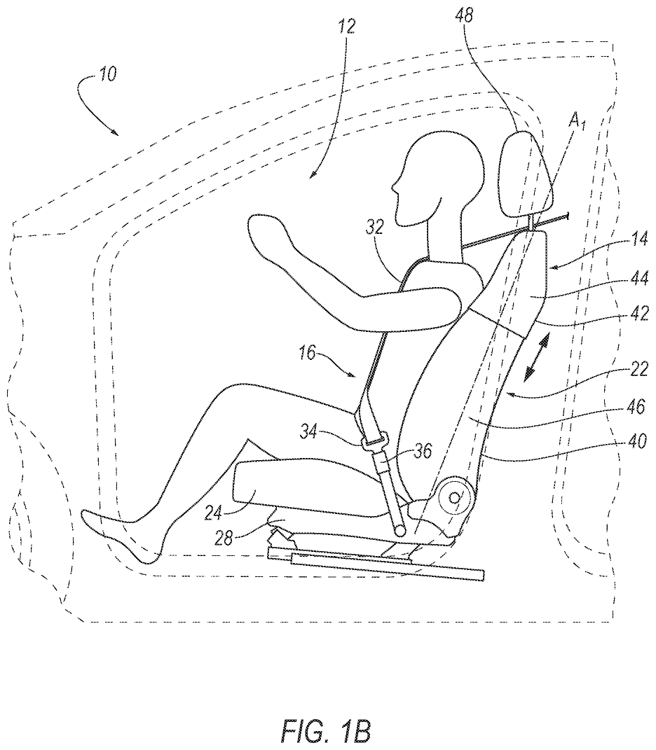

With reference to the Figures, where like numerals indicate like features throughout the several views, an example system of a vehicle 10 includes a seat assembly 14 having an extendable seatback 22 with a seatback frame 26 having a lower frame 50 and an upper frame 52 carried by and movable relative to the lower frame 50 between a retracted position (FIG. 1A) and an extended position (FIG. 1B). An actuator 60 is operatively coupled to the upper frame 52 to move the upper frame 52 between the retracted position and the extended position based on the size of an occupant seated on the seat assembly 14.

With reference to FIGS. 1A and 1B, the vehicle 10 may be any suitable type of ground vehicle, e.g., a passenger or commercial automobile such as a sedan, a coupe, a truck, a sport utility, a crossover, a van, a minivan, a taxi, a bus, etc. The vehicle 10 may define a passenger cabin 12 to house occupants, if any, of the vehicle 10. The passenger cabin 12 may extend across the vehicle 10, e.g., from a left side of the vehicle 10 to a right side of the vehicle 10. The passenger cabin 12 includes a front end and a rear end with the front end being in front of the rear end during forward movement of the vehicle 10.

One or more seat assemblies 14 may be supported in the passenger cabin 12, e.g., by a floor of the vehicle 10. Each seat assembly 14 can include a seatback 22 and a seat bottom 24 that can support the occupant of the seat assembly 14. For example, the occupant of the seat assembly 14 may sit atop a top surface of the seat bottom 24 and recline against the seatback 22. While seat 14 shown in the Figures is in the front passenger position, the disclosed technology can be applied to any seat in the vehicle.

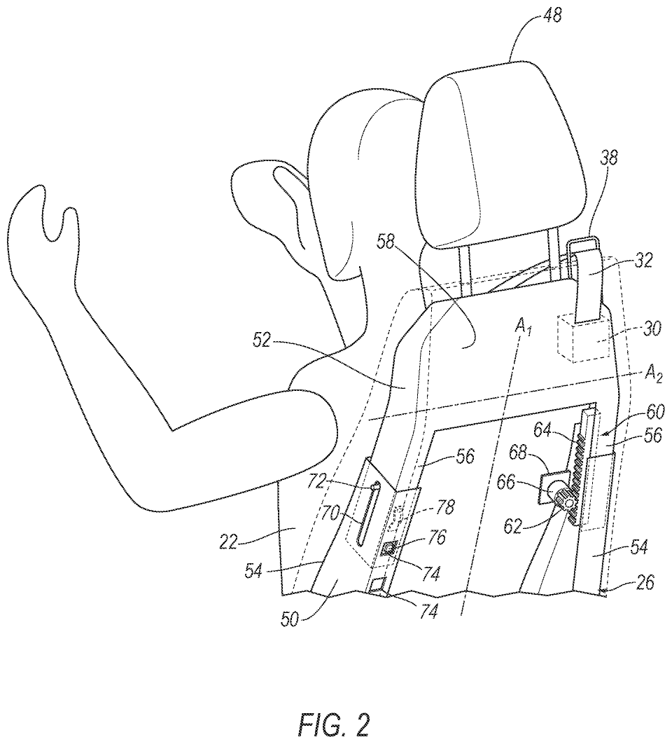

The seat bottom 24 can include a seat bottom frame 28. The frame 28 may include tubes, beams, etc. Specifically, the seat bottom frame 28 may include a pair of frame members elongated in the seat-forward direction, e.g., between a front end and a rear end of the seat bottom 24. The frame members can be spaced from each other along a seat-lateral axis (i.e., axis A2, FIG. 2). The frame 28 may include cross-members extending between the frame members. The seat bottom frame 28 can include a seat pan. The seat pan may be generally planar and extend from one of the frame members to the other of the frame members. The seat pan may be fixed to the frame members.

The seatback 22 is supported by the seat bottom 24, i.e., the weight of the seatback 22 is borne by the seat bottom 24. The seat bottom 24 extends from the seatback 22 in the seat-forward direction of the seat assembly 14. The seatback 22 may be stationary or movable relative to the seat bottom 24. The seatback 22 and the seat bottom 24 may be adjustable in multiple degrees of freedom. Specifically, the seatback 22 and the seat bottom 24 may themselves be adjustable, in other words, adjustable components within the seatback 22 and/or the seat bottom 24, and/or may be adjustable relative to each other.

The seatback 22 can include a lower portion 40 and an upper portion 42 that is movable between a retracted position (FIG. 1A) and an extended position (FIG. 1B) along a seat-vertical axis A1. The upper portion 42 may be adjusted between the retracted position and the extended position based on a detected size of the occupant, as described further below. The upper portion 42 may be adjusted relative to the lower portion 40 when the occupant initially occupies the seat assembly 14. As described further below, in some examples, the upper portion 42 may be adjusted to, and stopped at, positions between extended position and the retracted position based on the size of the occupant.

The webbing guide 38 and the headrest 48 can be supported by and movable with the upper portion 42. The upper portion 42 can be moved to the retracted position, extended position, or anywhere in between based on the size and/or height of an occupant seated on the seat 14. For example, the upper portion 42 can be extended in order to position the seatback 22, the headrest 48, and the webbing guide 38 to accommodate relatively tall occupants.

The seatback 22 and the seat bottom 24 can include suitable covers. The covers may include upholstery and padding. The upholstery may be cloth, leather, faux leather, or any other suitable material. The upholstery may be stitched in panels around the frames. The padding may be between the upholstery and the frames. The padding may be foam or any other suitable material. In an example, the seatback 22 can include overlapping upper and lower cover portions 44 and 46 to facilitate relative movement between the lower portion 40 and the upper portion 42. The upper cover portion 44 can slide over the lower cover portion 46. In an example, the upper and lower cover portions 44 and 46 can include plastic panels along the bolsters and on a back side of the seatback 22. The seat-forward side of the seatback 22 (e.g., the seating surface) can include upholstery such as cloth, leather, or faux leather that is formed into flexible overlapping panels and/or formed in an accordion configuration to expand and contract as the lower 40 and upper 42 portions move relative to each other.

With reference to FIG. 2, the seatback 22 includes a seatback frame 26. The seatback frame 26 can include a lower frame 50 and an upper frame 52 corresponding to the lower and the upper seatback portions 40 and 42, respectively. The upper frame 52 is carried by and movable relative to the lower frame 50 between the retracted position and the extended position. The lower frame 50 can include a pair of upright frame members 54. The upright frame members 54 are elongated, and specifically, are elongated in a generally upright direction (e.g., along the seat-vertical axis A1) when the seatback 22 is in a generally upright position. The upright frame members 54 are spaced from each other along the seat-lateral axis A2. The lower frame 50 may include one or more cross-members (not visible) extending between the upright frame members 54.

The upper frame 52 can include a pair of leg members 56 each extending in a generally downward direction (e.g., along the seat-vertical axis A1) to slidingly engage with a corresponding one of the pair of upright frame members 54. The leg members 56 are spaced from each other along the seat-lateral axis A2. The upper frame 52 may include one or more cross-members 58 extending between the leg members 56.

In an example, the upright frame members 54 and/or the leg members 56 can include channels or tubes that telescope relative to each other. In other words, the upright frame members 54 may telescopically receive the leg members 56 or the leg members 56 may telescopically receive the frame members 54. In such an example the upright frame members 54 are moveable relative to the leg members 56 between the extended position and the retracted position, as described herein. In the example shown in the Figures, the upright frame members 54 telescopically receive the leg members 56. In other examples, the leg members 56 may telescopically receive the upright frame members 54.

As depicted in FIG. 2, the leg members 56 are formed as channels that telescope into the upright frame members 54, which are also formed as channels. Specifically, in the example shown in the Figures, both upright frame member 54 include channels (not numbered) that respectively receive the leg members 56. In that example, the upright frame members 54, for example, have a U-shaped cross section and the leg members 56 are sized and shaped to be received in the U-shaped cross section with a clearance fit. In other examples, the leg members 56 have a U-shaped cross section and the upright frame members 54 are sized and shaped to be received by the leg members 56 with a clearance fit. In other examples, for example the upright frame members 54 and the leg members 56 may be tubular with the tubular shape being sized and shaped for a clearance fit. In such examples, the tubular shape can have any suitable cross-sectional profile, e.g., round, rectangular etc.

The seatback frame 26 and the seat bottom frame 28 may be of any suitable plastic material, e.g., carbon fiber reinforced plastic (CFRP), glass fiber-reinforced semi-finished thermoplastic composite (organosheet), etc. As another example, some or all components of the seatback frame 26 and the seat bottom frame 28 may be formed of a suitable metal, e.g., steel, aluminum, etc. In an example, the lower frame 50 and the upper frame 52 can be formed at least in part from stamped sheet metal components.

An actuator 60 is operatively coupled to the upper frame 52 to move the upper frame 52 between the retracted position and the extended position. In some examples, the actuator 60 can be a rack and pinion mechanism. The rack and pinion mechanism includes a gear rack 64 and a pinion gear 62 driven by an electric motor 66. The pinion gear 62 engages teeth on the gear rack 64. The gear rack 64 is secured to the upper frame 52 and the pinion motor 66 is secured to the lower frame 50 via a bracket 68. When the motor 66 is activated the pinion gear drives the gear rack 64 and the upper frame 52 up or down depending on the direction of the motor. As shown in the Figure, activating the motor 66 in the clockwise direction will move the upper frame 52 downward toward the retracted position and activating the motor 66 in the counter-clockwise direction will move the upper frame 52 upward toward the extended position. In an example, the distance between the retracted position and the extended position can be approximately two inches.

In an example, the upright frame member 54 can include a slot 70 within which a pin 72 can travel up and down with the leg member 56. The pin 72 is secured to the leg member 56 and limits the travel of the upper frame 52 relative to the lower frame 50.

In an example, the upright frame member 54 can include one or more apertures 74 positioned to receive a detent 76 extending from the leg member 56. The detent 76 engages one of the apertures 74 when a force is applied to the seatback 26 in a seat-forward direction. A leaf spring 78 can be positioned between the leg member 56 and the upright frame member 54 to maintain a clearance between the leg member 56 and the upright frame member 54. This clearance prevents the detent 76 from engaging the apertures 74 during operation of the extendable seatback 22. When a force is applied to the upper frame 52 in a seat-forward direction via e.g., the seatbelt webbing 32, the upper frame 52 cants or tilts within the lower frame 50 depressing the leaf spring 78 to engage the detent 76 with an aperture 74. The detent 76 engages the upper or lower aperture 74 depending on whether the upper frame 52 is in the extended or retracted position, respectively. The detent 76 can be a protrusion formed in the leg member 56 or a separate element secured to the leg member with a suitable fastener, weld, or the like.

The actuator 60 is contained within the seatback 22. In other words, the rack and pinion may be positioned under the seatback cover's upholstery and padding between the upright frame members and leg members, for example. The gear rack 64 can be secured to the upper frame 52 and the motor bracket 68 can be attached to the lower frame 50 with welds, fasteners, and/or other suitable structures.

The seat assembly 14 may include a head restraint 48. The head restraint 48 may be supported by and movable with the upper frame 52. The head restraint 48 may be at a top end of the seatback 22. The head restraint 48 may be stationary or movable relative to the seatback 22. The seatback 22 and the head restraint 48 may be adjustable in multiple degrees of freedom. Specifically, the seatback 22 and/or the head restraint 48 may themselves be adjustable and/or may be adjustable relative to each other.

Each seat assembly 14 has an associated seatbelt assembly 16. The seatbelt assembly 16 can include a retractor 30 and a webbing 32. The webbing 32 is retractably payable from the retractor 30. The seatbelt assembly 16 may include an anchor (not visible) fixed to the webbing 32 and a latch plate 34 that engages a buckle 36. In an example, the buckle 36 can be attached to the seat bottom 24. The webbing 32 may extend continuously from the retractor 30 through a webbing guide 38 and to the anchor. The webbing guide 38 can be fixed to and movable with the upper frame 52, for example. The webbing guide 38 is fixed to the cross member 58 of the upper frame 52. The latch plate 34 may slide freely along the webbing 32, and when engaged with the buckle 36, divide the webbing 32 into a lap belt and a shoulder belt. The webbing 32 may be fabric, e.g., polyester. In an example, the retractor 30 can be supported by the seatback frame 26. In some examples, the retractor 30 can be supported by the lower frame 50 or the upper frame 52.

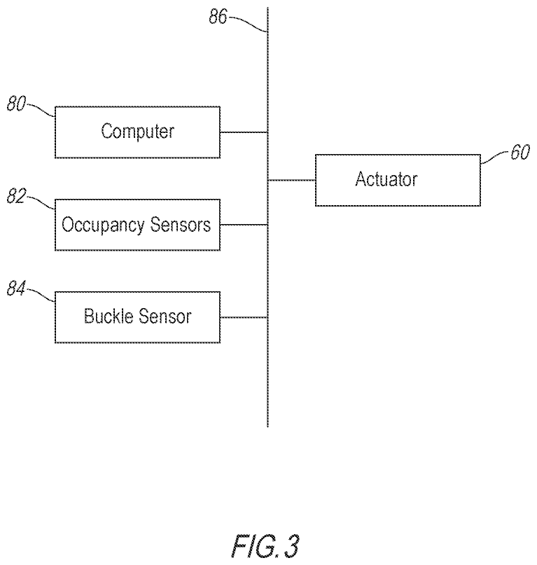

With reference to FIG. 3, the system can include the seat assembly 14 as well as a computer 80, a network 86, and various sensors, including occupancy sensors 82 and a buckle sensor 84. The vehicle 10 may include occupancy sensors 82 configured to detect occupancy of the seat assembly 14. The vehicle 10 may include a buckle sensor 84 that detects engagement of the latch plate 34 of the seatbelt assembly 16 with the buckle 36. The buckle sensor 84 may include a switch, a contact sensor, a hall effect sensor, or any other suitable structure for detecting engagement of the latch plate 34 with the buckle 36, including conventional structures. The buckle sensor 84 provides data to the computer 80 indicating whether the latch plate 34 is engaged with, or disengaged from, the buckle 36.

The computer 80 may be in communication with the occupancy sensors 82 via the network 86. The occupancy sensors 82 may be coupled to the seat assemblies 14 to identify when an occupant is seated in the seat assemblies 14. As an example, the occupancy sensors 82 may indicate to the computer 80 that a seat assembly 14 is occupied. For example, the occupancy sensors 82 may communicate to the computer 80, e.g., by sending a signal to the computer 80, that the seat assembly 14 is occupied and in the absence of such communication the computer 80 may classify the seat assembly 14 as unoccupied. As another example, the occupancy sensors 82 may be configured to communicate to the computer 80 that the seat assembly 14 is occupied when the seat assembly 14 is occupied and to communicate to the computer 80 that the seat assembly 14 is unoccupied when the seat assembly 14 is unoccupied, e.g., by sending a signal to the computer 80 when the seat assembly 14 is occupied and unoccupied indicating occupancy or lack thereof.

The occupancy sensors 82 may determine the size of the occupant seated in the seat assembly 14 when the seat assembly 14 is determined to be occupied. Based on the determined size of the occupant the computer 80 can selectively activate the actuator 60, e.g., motor 66, to move the upper portion 42 to the retracted or extended positions corresponding to e.g., the height of the occupant. The occupancy sensors 82 may determine, for example, the height and/or weight of the occupant in the seat assembly 14. As an example, the occupancy sensors 82 may determine a larger occupant is seated in the seat assembly 14. As another example, the occupancy sensors 82 may determine a smaller occupant is seated in the seat assembly 14. The size of the occupant may be based on a standards-setting body, e.g., a government agency such as the National Highway Traffic Safety Administration (NHTSA).

The occupancy sensors 82 may be, for example, a weight sensor, image detection, a seatbelt buckle sensor 84, etc. The vehicle 10 may include any suitable number of occupancy sensors 82. For example, the vehicle 10 may include a number of occupancy sensors 82 equal to the number of seats 14 in the vehicle 10. Specifically, in some examples, the occupancy sensor 82 may be of a conventional type currently known in the art. The occupancy sensor 82 detects at least one size measurement of the occupant, e.g., weight, width, height, etc. As an example, the occupancy sensor 82 may be a weight sensor in the seat assembly 14 for detecting the weight of the occupant. In such an example, the occupancy sensor 82 may include a sealed bladder and a pressure sensor in communication with the sealed bladder for detecting pressure changes in the bladder when an occupant sits on the seat 14. As another example, the occupancy sensors 82 may be a camera in the passenger cabin for detecting the size and/or shape of the occupant(s). In such an example, the camera can detect electromagnetic radiation in some range of wavelengths. For example, the camera may detect visible light, infrared radiation, ultraviolet light, or some range of wavelengths including visible, infrared, and/or ultraviolet light. The camera may be positioned such that a field of view of the camera encompasses the seat. Based on the detection by the occupancy sensors 82, an occupant-classification system (OCS) determines the size of an occupant seated in the seat 14. The size of the occupant may be classified based on anthropomorphic size identified in regional regulations. As examples, the OCS may classify the occupant as being within a size range associated with an adult occupant.

The vehicle 10 may include a communication network 86. The communication network 86 includes hardware, such as a communication bus, for facilitating communication among vehicle 10 components, e.g., the computer 80, the occupancy sensors 82, the buckle sensor 84, the actuator 60, etc. The communication network 86 may facilitate wired or wireless communication among the vehicle 10 components in accordance with a number of communication protocols such as controller area network (CAN), Ethernet, Wi-Fi, Local Interconnect Network (LIN), and/or other wired or wireless mechanisms. Alternatively or additionally, in cases where the computer 80 comprises a plurality of devices, the communication network 86 may be used for communications between devices represented as the computer 80 in this disclosure.

The computer 80 may be a microprocessor-based computer implemented via circuits, chips, or other electronic components. The computer 80 includes a processor, a memory, etc. The memory of the computer 80 may include memory for storing programming instructions executable by the processor as well as for electronically storing data and/or databases. For example, the computer 80 can be a generic computer with a processor and memory as described above and/or may include an electronic control unit (ECU) or controller for a specific function or set of functions, and/or a dedicated electronic circuit including an ASIC that is manufactured for a particular operation, e.g., an ASIC for processing sensor data and/or communicating the sensor data. As another example, the computer 80 may be a restraints control module. In another example, computer 80 may include an FPGA (Field-Programmable Gate Array) which is an integrated circuit manufactured to be configurable by a user. Typically, a hardware description language such as VHDL (Very High-Speed Integrated Circuit Hardware Description Language) is used in electronic design automation to describe digital and mixed-signal systems such as FPGA and ASIC. For example, an ASIC is manufactured on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included in the computer 80. The memory can be of any type, e.g., hard disk drives, solid state drives, servers, or any volatile or non-volatile media. The memory can store the collected data sent from the sensors.

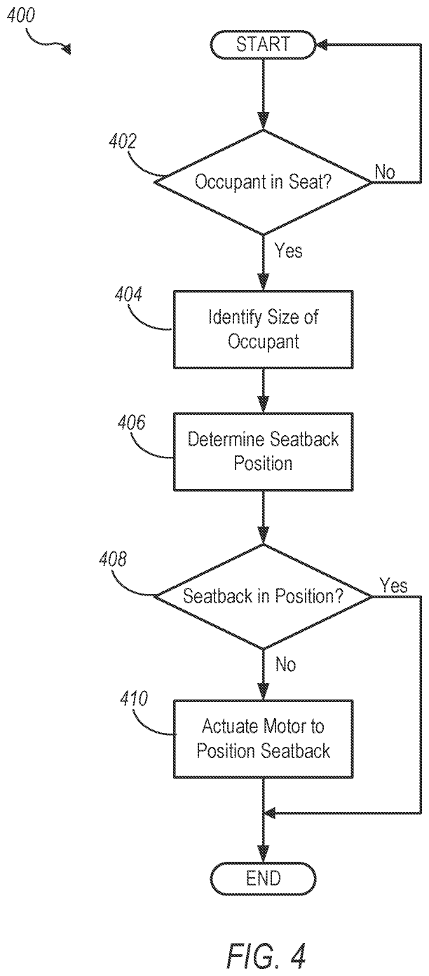

With reference to FIG. 4, the vehicle computer 80 stores instructions to control components of the vehicle 10 according to the method 400. Specifically, as shown in the Figure, the method 400 includes selectively actuating the motor 66 to position the seatback upper portion 42 based on a determination of the size of the occupant of the seat 14.

With reference to decision block 402, the method 400 includes identifying that an occupant is seated in the seat 14. The occupancy sensors 82 may notify the computer 80 that an occupant is seated in the seat 14, such as by sending a signal or lacking sending a signal. If no occupant is determined to be seated in the seat 14, the method 400 returns to its start. If an occupant is determined to be seated in the seat 14, the method 400 moves to block 404.

With reference to block 404, based on determining the seat 14 is occupied, the method 400 includes determining the size, e.g., height, of the occupant of the seat 14. The occupancy sensors 82 may send a signal notifying the computer 80 of the size of the occupant in the seat 14. The size of the occupant may be stored by the computer 80 to be used to determine where to position the upper portion 42 of the seatback 22.

With reference to block 406, the method 400 includes determining whether the upper portion 42 of the seatback 22 should be positioned in the extended or the retracted position. For example, if the size of the occupant is small the upper portion 42 could be in the retracted position. If the occupant is larger the upper portion 42 could be in the extended position. In some examples, the upper portion 42 can be positioned between the retracted and extended positions when, for example, the occupant's size is determined to be between a small occupant and a large occupant.

With reference to decision block 408, the method 400 includes comparing a current position of the upper portion 42 with the determined position from block 406. If the upper portion 42 is in the determined position, there is no need to actuate the seatback 22 and the method 400 ends. If the upper portion 42 is not in the determined position, the seatback 22 can be actuated to move the upper portion to the determined position at block 410.

With reference to block 406, the method 400 includes actuating motor 66 to move the upper portion 42 to the determined position. For example, the computer 80 can, actuate the motor 66 in the clockwise direction to move the upper frame 52 downward to the retracted position or actuate the motor 66 in the counter-clockwise direction will move the upper frame 52 upward toward the extended position.

Computing devices, such as the computer, generally include computer-executable instructions, where the instructions may be executable by one or more computing devices such as those listed above. Computer-executable instructions may be compiled or interpreted from computer programs created using a variety of programming languages and/or technologies. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same candidate numbers indicate the same elements. Further, some or all of these elements could be changed. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claimed invention. Any use of “based on” and “in response to” herein, including with reference to media, processes, systems, methods, etc. described herein, indicates a causal relationship, not merely a temporal relationship.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A system, comprising:
a seatback frame having a lower frame and an upper frame carried by and movable relative to the lower frame between a retracted position and an extended position; and
an actuator operatively coupled to the upper frame to move the upper frame between the retracted position and the extended position.

2. The seat system of claim 1, further comprising a webbing guide fixed to and movable with the upper frame.

3. The seat system of claim 2, further comprising a retractor supported by the seatback frame.

4. The seat system of claim 3, wherein the retractor is supported by the lower frame.

5. The seat system of claim 3, further comprising a webbing extending from the retractor through the webbing guide.

6. The seat system of claim 5, further comprising a seat bottom, a latch plate slidably disposed on the webbing, and a buckle attached to the seat bottom and operative to releasably engage the latch plate.

7. The seat system of claim 1, further comprising a head restraint supported by and movable with the upper frame.

8. The seat system of claim 1, wherein the actuator is a rack and pinion mechanism coupled to the upper frame and operative to move the upper frame between the retracted position and the extended position.

9. The seat system of claim 8, wherein the rack and pinion mechanism comprises a pinion gear and a gear rack, the gear rack being secured to the upper frame.

10. The seat system of claim 1, further comprising a seatback cover including a lower portion and an upper portion at least partially overlapping the lower portion.

11. The seat system of claim 1, wherein the upper frame includes a leg member slidingly engaged with the lower frame.

12. The seat system of claim 1, wherein the upper frame and the lower frame telescope relative to each other.

13. The seat system of claim 1, further comprising a computer having a processor and a memory storing instructions executable by the processor to activate the actuator and to move the upper frame between the retracted position and the extended position in response to determining that an occupant is seated in the seat.

14. The system of claim 13, wherein the instructions include instructions to adjust the position of the upper frame relative to the lower frame based on a determined size of the occupant.

15. The seat system of claim 13, further comprising an occupancy sensor.

16. The seat system of claim 13, further comprising a webbing guide fixed to and movable with the upper frame.

17. The seat system of claim 16, further comprising a head restraint supported by and movable with the upper frame.

18. The seat system of claim 16, further comprising a seat bottom, a latch plate slidably disposed on a webbing, and a buckle attached to the seat bottom and operative to releasably engage the latch plate.

19. The seat system of claim 13, wherein the actuator is a rack and pinion mechanism coupled to the upper frame and operative to move the upper frame between the retracted position and the extended position.

20. The seat system of claim 19, wherein the upper frame and the lower frame telescope relative to each other.
